(19) United States
(12) Patent Application Publication
(10) Pub. No.: US 2023/0394733 A1
(43) Pub. Date: Dec. 7, 2023

(54) PROCESSING DEVICE, PROCESSING METHOD AND PROGRAM

(71) Applicant: Nippon Telegraph and Telephone Corporation, Tokyo (JP)

(72) Inventors: Akira MORIKAWA, Musashino-shi, Tokyo (JP); Ryo KITAHARA, Musashino-shi, Tokyo (JP); Takao KURAHASHI, Musashino-shi, Tokyo (JP); Hajime NOTO, Musashino-shi, Tokyo (JP); Hiroko YABUSHITA, Musashino-shi, Tokyo (JP); Chihiro TAKAYAMA, Musashino-shi, Tokyo (JP); Ryohei SAIJO, Musashino-shi, Tokyo (JP)

(21) Appl. No.: 18/032,245

(22) PCT Filed: Oct. 23, 2020
(86) PCT No.: PCT/JP2020/039944

§ 371 Date: Apr. 17, 2023

(51) Int. Cl. G06T 13/40; A63F 13/55

(52) U.S. Cl. CPC G06T 13/40; A63F 13/55

(57) ABSTRACT

A processing device includes an acquisition unit that acquires an instruction to specify a conscious behavior of a target that reproduces a behavior of a user, a determination unit that determines a parameter for reproducing an unconscious behavior corresponding to the conscious behavior specified by the instruction from unconscious parameter data in which an identifier of a conscious behavior of the user, an identifier of an unconscious behavior in the conscious behavior, and an index for specifying a parameter for reproducing the unconscious behavior are associated with each other, and an output unit that outputs a determined parameter to a drive unit TD of the target T, in which a parameter for reproducing the unconscious behavior varies depending on the conscious behavior.

### TECHNICAL FIELD

The present invention relates to a processing device, a processing method and a program.

### BACKGROUND ART

Recently, a digital twin has been widespread. In the digital twin, devices and facilities are constructed on a virtual space, and simulation is performed using the digital information. The digital twin enables design improvement, failure prediction, and the like.

On the other hand, each individual can also be formed as a digital twin of a human in a virtual space using an avatar that is active in the virtual space.

Furthermore, there is a method for modeling various emotions or speaker styles in speech synthesis using HMM (Non Patent Literature 1).

### CITATION LIST

### Non Patent Literature

Non Patent Literature 1: Junichi YAMAGISHI, Koji ONISHI, Takashi MASUKO, and Takao KOBAYASHI, “Acoustic Modeling of Speaking Styles and Emotional Expressions in HMM-Based Speech Synthesis”, IEICE TRANS. INF. & SYST., VOL. E88-D, NO. 3 March 2005

### SUMMARY OF INVENTION

### Technical Problem

In the digital twin, expressing emotions and actions, not by arranging a plurality of the same avatars, but by a plurality of avatars having respective personalities as in people in the real world has been attempted.

In order to impart a personality to an avatar, there is a method for expressing individual emotions and movements on a virtual space after storing facial expressions or actions of a user on a server in advance. However, a human does not always show the same reaction to an external stimulus, and the personality of the user may not be sufficiently exhibited in behaviors of the user reproduced on the virtual space.

Therefore, technology for reproducing natural behaviors of a user in a target such as an avatar has been expected by varying unconscious behaviors such as appearance of a specific habit and breathing according to a conscious behavior of the user and the like.

The present invention has been made in view of the above circumstances, and an object of the present invention is to provide technology for reproducing natural behaviors of a user in a target.

### Solution to Problem

A processing device of an aspect of the present invention includes an acquisition unit that acquires an instruction to specify a conscious behavior of a target that reproduces a behavior of a user, a determination unit that determines a parameter for reproducing an unconscious behavior corresponding to the conscious behavior specified by the instruction from unconscious parameter data in which an identifier of a conscious behavior of the user, an identifier of an unconscious behavior in the conscious behavior, and an index for specifying a parameter for reproducing the unconscious behavior are associated with each other, and an output unit that outputs a determined parameter to a drive unit of the target, in which a parameter for reproducing the unconscious behavior varies depending on the conscious behavior.

A processing method of an aspect of the present invention includes a step in which a computer acquires an instruction to specify a conscious behavior of a target that reproduces a behavior of a user, a step in which the computer determines a parameter for reproducing an unconscious behavior corresponding to the conscious behavior specified by the instruction from unconscious parameter data in which an identifier of a conscious behavior of the user, an identifier of an unconscious behavior in the conscious behavior, and an index for specifying a parameter for reproducing the unconscious behavior are associated with each other, and a step in which the computer outputs a determined parameter to a drive unit of the target, in which a parameter for reproducing the unconscious behavior varies depending on the conscious behavior.

An aspect of the present invention is a program for causing a computer to function as the above processing device.

### Advantageous Effects of Invention

According to the present invention, technology for reproducing natural behaviors of a user in a target can be provided.

### BRIEF DESCRIPTION OF DRAWINGS

FIG. 1 is a diagram illustrating a processing system and a processing device according to an embodiment of the present invention.

FIG. 2 is a diagram illustrating an example of a data structure and data of instruction data.

FIG. 3 is a diagram illustrating an example of a data structure and data of unconscious parameter data.

FIG. 4 is a diagram illustrating an example of a data structure and data of motion data.

FIG. 5 is a diagram illustrating an example of a data structure and data of motion instruction data.

FIG. 6 is a flowchart illustrating processing of the processing device.

FIG. 7 is a diagram illustrating a hardware configuration of a computer used in the processing device.

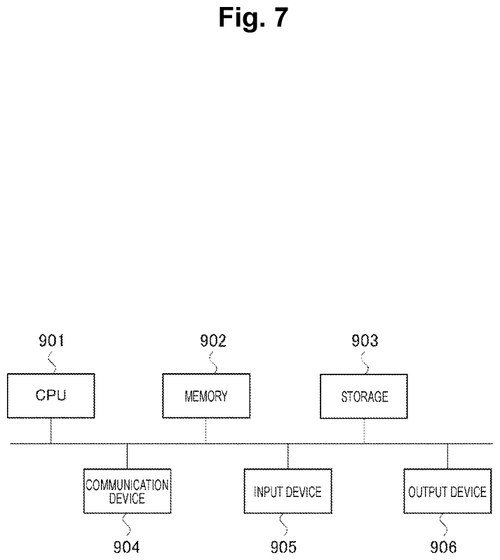

### DESCRIPTION OF EMBODIMENT

Hereinafter, an embodiment of the present invention will be described with reference to the drawings. In the drawings, the same portions are denoted by the same reference signs, and a description thereof is omitted.

(Processing System)

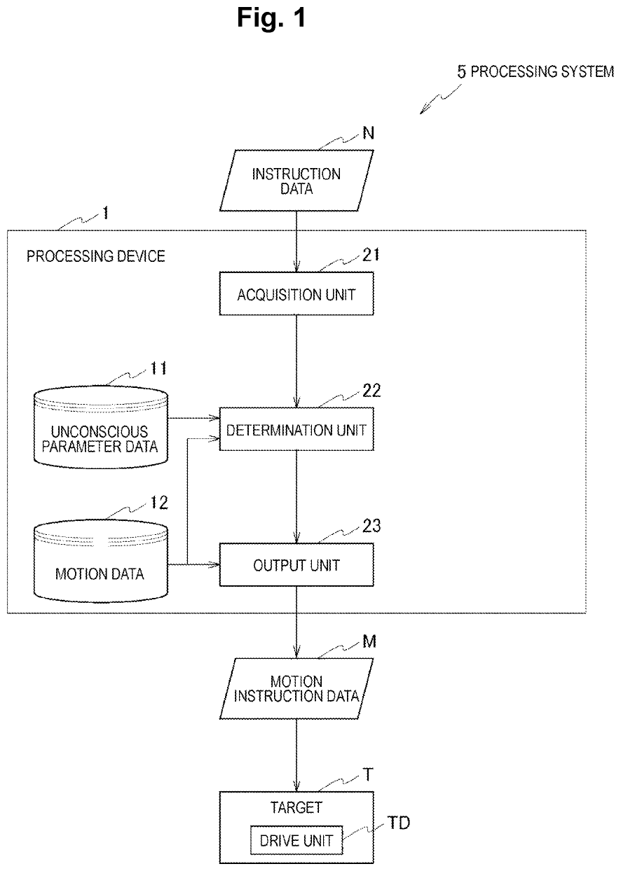

A processing system 5 according to the embodiment of the present invention will be described with reference to FIG. 1. The processing system 5 includes a processing device 1 and a target T. The processing system 5 reproduces natural behaviors of a user in the target T.

The target T reproduces behaviors of a user. The target T is driven in accordance with an instruction from a drive unit TD formed by using a computer.

The target T is, for example, a robot that is active in the real world, an avatar that is active in a virtual space, or the like. The target T may be formed by imitating a user himself/herself, or may be formed by imitating a character other than the user, an object other than a human, or the like. The object other than a human may be a creature, or may be any object such as a rock, a tree, a cloud, or a celestial body. In the target T, behaviors of a user may be reproduced by the entire individual of a robot or a human, or behaviors of a user may be reproduced by a part of a robot or a human such as an arm, a face, or a head. Furthermore, the target T may be formed by using a part of the individual such as only a face portion or only an upper body. The robot may be formed from any member such as metal or a member imitating skin. The avatar is controlled by the drive unit TD so as to be active in the virtual space.

Note that, in an example illustrated in FIG. 1, the target T is described to include the drive unit TD, but the present invention is not limited thereto. The drive unit TD may be installed outside the housing of the target T. Furthermore, the target T and the drive unit TD may be implemented inside the computer, for example, in a case where the target T is an avatar.

The processing device 1 according to the embodiment of the present invention adds unconscious behaviors reflecting the personality of a user to a conscious behavior reproduced in the target T, thereby reproducing natural behaviors of the user in the target T. At this time, the processing device 1 varies the unconscious behaviors depending on the conscious behavior reproduced by the target T, the situation of the target T, and the like, thereby reproducing more natural behaviors.

In the embodiment of the present invention, behaviors of the target T will be described being distinguished into conscious behaviors and unconscious behaviors. The conscious behaviors are behaviors that a user consciously performs based on user's own decision. The conscious behaviors are specified in advance as behaviors that the target T is caused to perform in instruction data N. The conscious behaviors are, for example, smiling, utterance of “hello”, and “bowing” when making a greeting. On the other hand, the unconscious behaviors are behaviors that a user performs independently of user's own decision. The unconscious behaviors are behaviors added by the processing device 1 when reproducing the behaviors specified in the instruction data N. The unconscious behaviors are physiological movements of breathing, blinking, and the like, an unintentional habit, and the like. Note that the unconscious behaviors of a habit, breathing, blinking, and the like may be specified by the instruction data N. In this case, the processing device 1 adds unconscious behaviors that do not conflict with behaviors specified by the instruction data N.

In the embodiment of the present invention, the target T reproduces behaviors of a user according to an instruction of the drive unit TD, and conscious behaviors by the target T in that case are behaviors estimated to be performed consciously by the user based on user's own decision. The unconscious behaviors by the target T are behaviors estimated to be unconsciously performed when a user consciously behaves based on user's own decision.

When conscious behaviors to be reproduced in the target T are specified, the processing device 1 according to the embodiment of the present invention also reproduces unconscious behaviors reflecting the personality of a user in the target T. The unconscious behaviors are controlled by the processing device 1 so as to vary according to the personality of an individual user. Furthermore, the unconscious behaviors, and the conscious behaviors reproduced by the target T vary depending on the situation of the target T and the like. When the target T reproduces a conscious behavior, the target T also reproduces unconscious behaviors reflecting the personality of a user during the behavior, so that the target T can be caused to reproduce natural behaviors of the user.

(Processing Device)

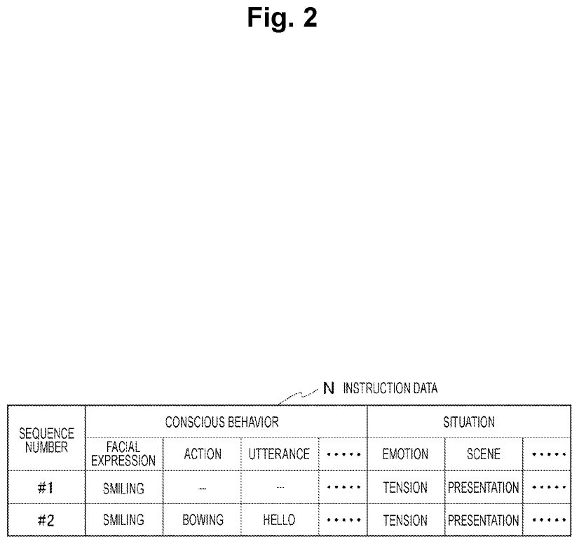

The processing device 1 acquires instruction data N illustrated in FIG. 2. The processing device 1 adds unconscious behaviors to conscious behaviors specified by the instruction data N to generate motion instruction data M that can be read by the drive unit TD of the target T.

The instruction data N specifies conscious behaviors of the target T that reproduces behaviors of a user.

An example of the instruction data N will be described with reference to FIG. 2. In the instruction data N illustrated in FIG. 2, sequence numbers, conscious behaviors, and situations are set. In a case where the processing device 1 processes instruction data N of a plurality of targets T, identifiers of the targets T may be set in the instruction data N. Since the instruction data N includes a plurality of data sets in which a plurality of sequence numbers is set, the target T can be caused to reproduce a plurality of behaviors in sequence number order.

In FIG. 2, the conscious behaviors are set being classified into three types of facial expression, action, and utterance. One or more behaviors are required to be set as the instruction data N. A sequence number #1 indicates that a facial expression “smiling” is performed. A sequence number #2 indicates that an action of “bowing” is performed with the facial expression of “smiling” and utterance of “hello” is performed. Furthermore, in order to determine behaviors of the target T, conscious behaviors may be set with fine granularity in a body part and the like such as a hand, a right eye, and a left eye.

In the instruction data N illustrated in FIG. 2, a situation is associated with each of the data sets. The situation associates any one or more of a scene where the target T is positioned and a state of the target T. The scene where the target T is positioned specifies an external situation in which the target T is arranged, such as “presentation” or “first meeting”. In a scene of “presentation”, the situation of the target T may be set in more detail, such as “the room is hot”, “there is an audience listening with no response such as nodding but staring”, or the like. In order to specify the external situation of the target, a sound that can be heard at the position of the target T may be included. The state of the target T specifies an internal situation of the target T such as emotion, physical strength, fatigue, and concentration.

In the embodiment of the present invention, the situation set in the instruction data N is one of conditions that cause unconscious behaviors. The unconscious behaviors reproduced in the target T may be determined in consideration of a situation in addition to a conscious behavior specified by the instruction data N. For example, unconscious behaviors may be determined from an external situation such as a scene, or the unconscious behaviors may be determined from an internal situation of the target T such as a state. The unconscious behaviors may be determined from a complex situation of external and external situations. Furthermore, the unconscious behaviors may be determined from an internal situation specified from an external situation. For example, an internal situation of “tension increases” is specified from an external situation of “there is an audience listening with no response such as nodding but staring”, and an unconscious behavior of “sweating” is determined from the internal situation of “tension increases”.

A description will be described regarding processing in which the processing device 1 generates motion instruction data M to which unconscious behaviors reflecting the personality of a user are added from the instruction data N in which conscious behaviors of the target T are specified

The processing device 1 includes unconscious parameter data 11, motion data 12, an acquisition unit 21, a determination unit 22, and an output unit 23. The unconscious parameter data 11 and the motion data 12 are data stored in a storage device such as a memory 902 or a storage 903. The acquisition unit 21, the determination unit 22, and the output unit 23 are processing units implemented in a CPU 901.

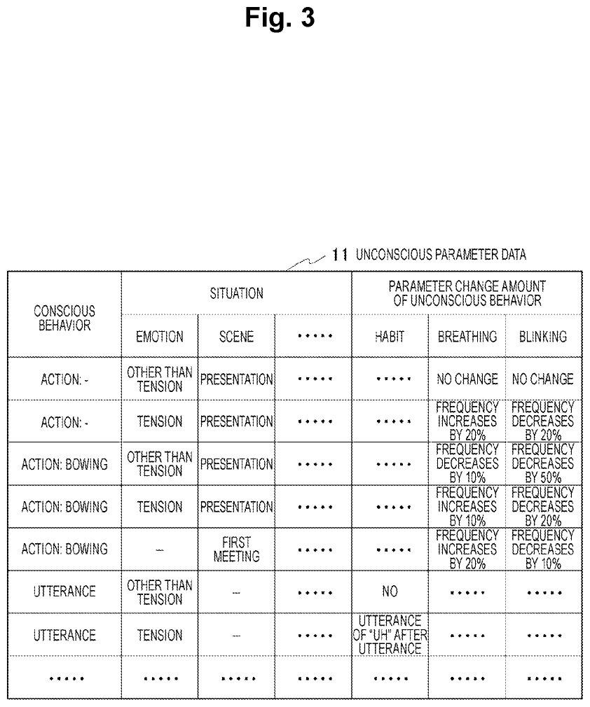

The unconscious parameter data 11 is data that associates identifiers of conscious behaviors of a user, identifiers of unconscious behaviors in the conscious behavior, and indexes for specifying parameters for reproducing the unconscious behaviors with each other. An identifier of a conscious behavior is data specifying a conscious behavior reproduced by the target T. An identifier of an unconscious behavior is data specifying an unconscious behavior reproduced by the target T. In an example of the unconscious parameter data 11 illustrated in FIG. 3, a conscious behavior is character data such as “action: -” indicating any action and “action: bowing” indicating a bowing action. “Action: -” indicates any action. “Action: bowing” indicates a bowing action. An identifier of an unconscious behavior is character data such as “habit”, “breathing”, and “blinking”. The identifier of a conscious behavior and the identifier of an unconscious behavior may be a code or the like including numerical symbols or the like or may have any form as long as the processing device 1 can specify the behavior.

A parameter for reproducing an unconscious behavior specifies any one or more of a speed, a frequency, and a pattern in the unconscious behavior. For example, for an unconscious behavior “breathing”, data for specifying a breathing speed, a breathing frequency, a breathing pattern, or the like in a predetermined conscious behavior and situation is set as a parameter of the unconscious parameter data 11. The breathing pattern is a pattern of repeating “inhaling” and “exhaling” that varies depending on a conscious behavior of a user or the like, such as a pattern of repeating “inhaling” and “exhaling” and a pattern of repeating “inhaling” twice and then repeating “exhaling” twice.

In the example of the unconscious parameter data 11 illustrated in FIG. 3, as indexes for specifying parameters for reproducing unconscious behaviors, change amounts of the parameters relative to default, such as a change amount of a breathing frequency and a change amount of a blinking frequency, are set instead of values of the parameters themselves. Parameters for reproducing unconscious behaviors are determined from the change amounts of the parameters set in the unconscious parameter data 11. For example, in a case where the scene is “presentation” and the emotion is “other than tension”, breathing and blinking do not change from the default data, on the other hand, in a case where the emotion is “tension”, a breathing frequency is increased by 20% relative to the default and a blinking frequency is decreased by 20% relative to the default. In the motion data 12 to be described below, a default breathing frequency and a default blinking frequency are set for the user, and thus the parameters under a specific condition are determined.

Note that, FIG. 3 illustrates merely an example in which change amounts relative to the default time are set as indexes for specifying parameters of unconscious behaviors of the unconscious parameter data 11, and the present invention is not limited thereto. For example, values themselves in a predetermined conscious behavior and situation that are a breathing frequency, a blinking frequency, and the like may be set in the unconscious parameter data 11 as indexes for specifying parameters of unconscious behaviors.

As illustrated in FIG. 3, the indexes for specifying parameters of the unconscious parameter data 11 may be further associated with the situation of the target T. The parameters of unconscious behaviors are set for a conscious behavior, and may be set also in further consideration of the situation of the target T.

As illustrated in FIG. 3, even in a case where “-” is specified as a conscious behavior and a specific behavior is not set, parameters for determining unconscious behaviors of breathing, blinking, a habit, and the like may be set. Since the parameters of unconscious behaviors are associated with any one of a conscious behavior or a situation, even in a case where a conscious action is not reproduced, unconscious behaviors that closely reflect the personality of each user according to the situation or the like can be added.

Note that, in the unconscious parameter data 11 illustrated in FIG. 3, “-” indicates any setting. In FIG. 3, two data sets of conscious behaviors of “action: -” and “action: bowing” are included in a situation of “emotion: tension” and “scene: presentation”. In this case, the parameters may be determined only from a data set in which a specific action (“action: bowing”) is set as a conscious behavior, or the parameters may be determined in further consideration of a data set in which “action: -” is set.

In a case where the parameters are only determined from the data set in which the specific action (“action: bowing”) is set, a breathing frequency is 1.1 times higher than the default and a blinking frequency is 0.8 times higher than the default. Furthermore, in a case where the parameters are determined from the two data sets in which the specific action (“action: bowing”) and any setting (“action: -”) are set, the breathing frequency is 1.1*1.2 times higher than the default and the blinking frequency is 0.8*0.8 times higher than the default. In the unconscious parameter data 11, a relation between a conscious behavior and change amounts of parameters may be appropriately set.

Furthermore, although the unconscious parameter data 11 illustrated in FIG. 3 specifies only “utterance” as a conscious behavior, parameters of unconscious behaviors may be set to vary depending on the utterance content. For example, change amounts of parameters of the unconscious parameter data 11 may be set such that different parameters are determined for a case where the utterance content is positive content and for a case where the utterance content is negative content.

The unconscious parameter data 11 is required to be referred to in order to specify parameters of unconscious behaviors relative to a conscious behavior, and a method for setting the parameters of the unconscious behaviors and a method for calculating values thereof are not specified.

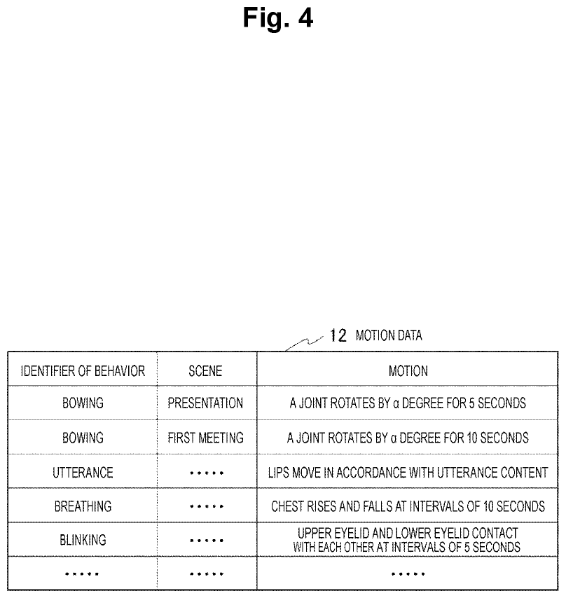

As illustrated in FIG. 4, the motion data 12 is data that associates identifiers of behaviors with motions for reproducing the behaviors in the target T. An identifier of a behavior identifies a conscious behavior or an unconscious behavior that can be reproduced by the target T. A motion is data that can be recognized by the drive unit TD of the target T. In the motion column, a value of a default parameter that is data for associating a body part of the target T with the movement thereof is set. As will be described below, the value of the default parameter is changed by the determination unit 22 to a value reflecting the personality of a user according to a parameter change amount of the unconscious parameter data 11.

In an example illustrated in FIG. 4, motions are specified by identifiers of behaviors and scenes, but the motions may be set for other types of situations such as emotions.

Note that the unconscious parameter data 11 and the motion data 12 are formed so as to reflect unique behaviors of a user that the target T is caused to reproduce. For example, the unconscious parameter data 11 and the motion data 12 may be provided for each user. Furthermore, default data used for general purposes and data for each user that specifies a difference from the default may be provided.

The acquisition unit 21 acquires the instruction data N that has been described with reference to FIG. 2. The acquisition unit 21 may further acquire a state of the target T. Situations of the target T may be set in the instruction data N as illustrated in FIG. 2. The acquisition unit 21 may acquire a situation of the target T by accessing a server or the like that can acquire the installation situation and the like of the target T.

The determination unit 22 determines, from the unconscious parameter data 11, parameters for reproducing unconscious behaviors corresponding to conscious behaviors specified by the instruction data N. Here, the parameters for reproducing unconscious behaviors are controlled so as to vary depending on the conscious behaviors.

For the conscious behaviors specified by the instruction data N, the determination unit 22 refers to the unconscious parameter data 11 and acquires unconscious behaviors added to the conscious behaviors and the change amounts of the parameters for reproducing the unconscious behaviors. The determination unit 22 determines the parameters for reproducing the unconscious behaviors by reflecting the change amounts acquired from the unconscious parameter data 11 in default parameters defined in the motion data 12.

In a case where the acquisition unit 21 acquires the situation of the target T, the determination unit 22 may determine parameters for reproducing unconscious behaviors corresponding to the acquired situation of the target T.

In the sequence number #1 of the instruction data N illustrated in FIG. 2, an action “-”, an emotion “tension”, and a scene “presentation” are set. The determination unit 22 adds unconscious behaviors of breathing and blinking from the unconscious parameter data 11 to a conscious behavior of the sequence number #1, and acquires breathing “frequency increases by 20%” and blinking “frequency decreases by 20%” as these parameters. In addition, the determination unit 22 acquires breathing “chest rises and falls at intervals of 10 seconds” and blinking “upper eyelid and lower eyelid contact with each other at intervals of 5 seconds” from the motion data 12 illustrated in FIG. 4.

The determination unit 22 adds, to the conscious behavior of the sequence number #1 of the instruction data N, two unconscious behaviors of breathing “chest rises and falls at intervals of (10/1.2) seconds” and blinking “upper eyelid and lower eyelid contact with each other at intervals of (5/0.8) seconds”. Similarly, the determination unit 22 determines parameters for reproducing unconscious behaviors for a facial expression “smiling” and utterance “-” that are other conscious behaviors of the sequence number #1 of the instruction data N.

In a sequence number #2 of the instruction data N illustrated in FIG. 2, utterance of “hello” during an emotion “tension” is set. The determination unit 22 adds unconscious behaviors of a habit from the unconscious parameter data 11 to a conscious behavior of the sequence number #2, and acquires “utterance of ‘uh’ after utterance” as a parameter of the habit. The determination unit 22 adds three unconscious behaviors of “utterance of ‘uh’ after utterance” in addition to breathing and blinking, to the conscious behavior of the sequence number #2 in the instruction data N.

Note that the method for determining parameters of unconscious behaviors described herein is an example, and the method is not limited thereto. Unconscious behaviors and the parameters for causing the target T to reproduce the unconscious behaviors may be set according to the conscious behavior, the situation, and the like specified in the instruction data N. Similarly, the determination unit 22 determines parameters for reproducing unconscious behaviors for a facial expression “smiling” and an action “bowing” that are other conscious behaviors of the sequence number #2 of the instruction data N.

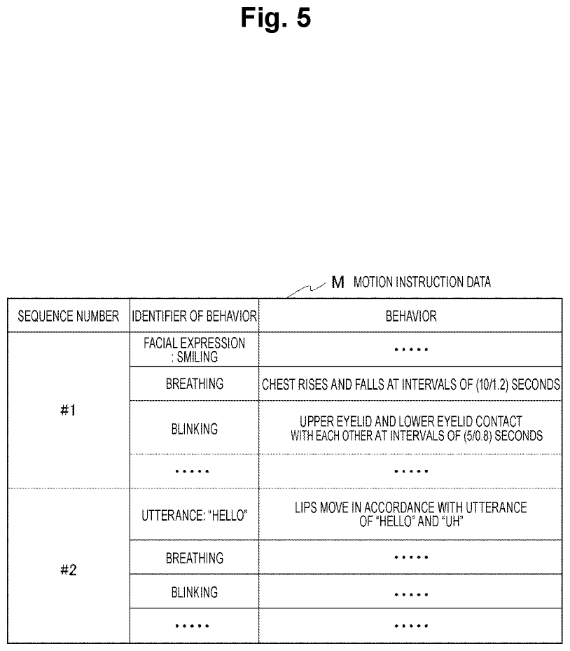

The output unit 23 outputs parameters determined by the determination unit 22 to the drive unit TD of the target T. The output unit 23 outputs, for example, the motion instruction data M illustrated in FIG. 5 to the drive unit TD of the target T.

The motion instruction data M, for each sequence number of the instruction data N, associates identifiers of behaviors to be reproduced by the target T in the sequence with specific movements of the behaviors. For example, in a sequence number #1, unconscious behaviors of breathing, blinking, or the like are added in addition to a conscious behavior of a facial expression “smiling”. Furthermore, specific movements of the unconscious behaviors are calculated from the personality of a user, the conscious behavior, and the situation of the target T. In a sequence number #2, unconscious behaviors of breathing and blinking are added in addition to a habit of utterance of “uh” after a conscious behavior of utterance of “hello”. The “uh” after the utterance of “hello” is added as an unconscious behavior of the user.

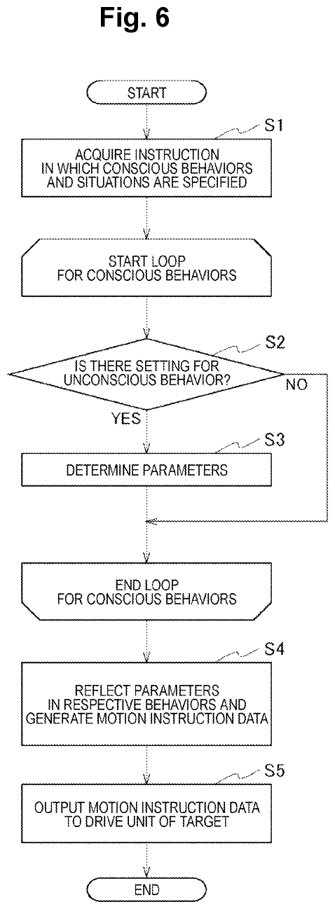

A processing method by the processing device 1 will be described with reference to FIG. 6.

In step S1, the processing device 1 acquires instruction data N in which conscious behaviors and situations are specified. Processing from step S2 to step S3 is repeated for each of the conscious behaviors specified by the instruction data N.

In step S2, the processing device 1 determines whether there is a setting for a conscious behavior to be processed in the unconscious parameter data 11. For example, in the unconscious parameter data 11, whether there is a specific behavior specified as the conscious behavior or “-” specified as any behavior in the instruction data N. In a case where there is no setting for the conscious behavior, since there is no unconscious behavior to be added by the processing device 1, processing of step S2 is performed for the next conscious behavior.

In step S2, in a case where there is a setting for the conscious behavior to be processed in the unconscious parameter data 11, the processing device 1 determines parameters for reproducing unconscious behaviors in the target T from the unconscious parameter data 11 and motion data 12 in step S3.

In a case where processing from step S2 to step S3 ends for each of the conscious behaviors specified by the instruction data N, in step S4, the processing device 1 reflects the parameters determined in step S3 in respective behaviors and generates motion instruction data M. The motion instruction data M generated here is data in which unconscious behaviors reflecting the personality of a user are added to the conscious behaviors specified by the instruction data N.

In step S5, the processing device 1 outputs the motion instruction data M generated in step S4 to the drive unit TD of the target T. Since the target T can be driven in accordance with the motion instruction data M, natural behaviors reflecting the personality of the user can be performed.

The processing device 1 can generate motion data 12 to which unconscious behaviors reflecting the personality of the user are added according to conscious actions, situations, and the like. As a result, unique and natural behaviors reflecting the personality of the user can be reproduced in the target T.

The processing device 1 of the present embodiment described above is, for example, a general-purpose computer system including a central processing unit (CPU, processor) 901, the memory 902, the storage 903 (hard disk drive (HDD), solid state drive (SSD)), a communication device 904, an input device 905, and an output device 906. In the computer system, by the CPU 901 performing a predetermined program loaded on the memory 902, each function of the processing device 1 is implemented.

Note that the processing device 1 may be implemented by one computer, or may be implemented by a plurality of computers. Note that the processing device 1 may be a virtual machine that is implemented in a computer.

The program for the processing device 1 can be stored in a computer-readable recording medium such as an HDD, an SSD, a universal serial bus (USB) memory, a compact disc (CD), or a digital versatile disc (DVD), or can be distributed via a network.

Note that the present invention is not limited to the above embodiment, and various modifications can be made within the scope of the gist of the present invention.

### REFERENCE SIGNS LIST

1 Processing device
5 Processing system
11 Unconscious parameter data
12 Motion data
21 Acquisition unit
22 Determination unit
23 Output unit
901 CPU
902 Memory
903 Storage
904 Communication device
905 Input device
906 Output device
M Motion instruction data
N Instruction data
T Target
TD Drive unit

1. A processing device comprising:
an acquisition unit, comprising one or more processors, configured to acquire an instruction to specify a conscious behavior of a target that reproduces a behavior of a user;
a determination unit, comprising one or more processors, configured to determine a parameter for reproducing an unconscious behavior corresponding to the conscious behavior specified by the instruction from unconscious parameter data in which an identifier of a conscious behavior of the user, an identifier of an unconscious behavior in the conscious behavior, and an index for specifying a parameter for reproducing the unconscious behavior are associated with each other; and
an output unit, comprising one or more processors, configured to output a determined parameter to a drive unit of the target,
wherein a parameter for reproducing the unconscious behavior varies depending on the conscious behavior.

2. The processing device according to claim 1, wherein the unconscious behavior is any one or more of a habit, breathing, and blinking of the user.

3. The processing device according to claim 1,
wherein a parameter for reproducing the unconscious behavior specifies any one or more of a speed, a frequency, and a pattern in the unconscious behavior.

4. The processing device according to claim 1,
wherein an index for specifying a parameter of the unconscious parameter data is further associated with a situation of the target,
the acquisition unit further acquires a state of the target, and
the determination unit determines a parameter for reproducing an unconscious behavior corresponding to an acquired situation of the target.

5. The processing device according to claim 1,
wherein a situation of the target specifies any one or more of a scene in which the target is positioned and a state of the target.

6. A processing method comprising:
acquiring an instruction to specify a conscious behavior of a target that reproduces a behavior of a user;
determining a parameter for reproducing an unconscious behavior corresponding to the conscious behavior specified by the instruction from unconscious parameter data in which an identifier of a conscious behavior of the user, an identifier of an unconscious behavior in the conscious behavior, and an index for specifying a parameter for reproducing the unconscious behavior are associated with each other; and
outputting a determined parameter to a drive unit of the target,
wherein a parameter for reproducing the unconscious behavior varies depending on the conscious behavior.

7. A recording non-transitory computer readable medium storing a program processing program, where executing of the program causes one or more computers to perform operations comprising:
acquiring an instruction to specify a conscious behavior of a target that reproduces a behavior of a user;
determining a parameter for reproducing an unconscious behavior corresponding to the conscious behavior specified by the instruction from unconscious parameter data in which an identifier of a conscious behavior of the user, an identifier of an unconscious behavior in the conscious behavior, and an index for specifying a parameter for reproducing the unconscious behavior are associated with each other; and
outputting a determined parameter to a drive unit of the target,
wherein a parameter for reproducing the unconscious behavior varies depending on the conscious behavior.
